(19) United States
(12) Patent Application Publication
(10) Pub. No.: US 2006/0038907 A1
(43) Pub. Date: Feb. 23, 2006

(54) Display apparatus and imaging apparatus

(76) Inventor: Hironori Katsuura, Osaka (JP)

Correspondence Address: RATNERPRESTIA, P.O. BOX 980, VALLEY FORGE, PA, 19482, US

(21) Appl. No.: 11/184,646

(22) Filed: Jul. 19, 2005

(30) Foreign Application Priority Data
Jul. 20, 2004 (JP) 2004-211306

(51) Int. Cl. H04N 5/222

(52) U.S. Cl. 348/333.01

(57) ABSTRACT

A display apparatus (for example, digital camera) includes a display section (for example, LCD monitor) that selectively displays one of a plurality of display patterns, and has a plurality of operation modes, an operation section (for example, operation button) that receives a short-time operation which is operated by a user for a shorter period than a specified time and a long-time operation which is operated by a user for a longer period than the specified time, and a controller that controls the display section so that the display pattern of the display section is charged over every time the operation section receives the short-time operation while the operation mode of the display section is charged over every time the operation section receives the long-time operation.

### BACKGROUND OF THE INVENTION

1. Field of the Invention

The present invention relates to a display apparatus and an imaging apparatus such as digital cameras, etc. which can change over display patterns on the display section and operation modes.

2. Related Art

For example, the JP11-261852A discloses a monitor button which is a pushbutton capable of cyclically changing over display states on the LCD monitor, including states in which “the synthesized image data and information are displayed”, “only image details displayed”, and “LCD monitor is turned off”.

Use of this button allows the display screen to be changed over at a stretch by a simple operation, resulting in convenience for users.

Usually, a digital camera is provided with a liquid crystal display (LCD) unit for monitoring an image to be taken or reviewing captured images. The LCD is generally easier to view as it is brighter. However, it is not preferable in view of power consumption to control the LCD to be always bright. It is preferable to change over operation modes of the digital camera to control the LCD to be bright only when needed.

The digital camera can display information, such as several information about imaging mode, superposed over image data on the LCD. Users can change over the superposed information to be displayed by pressing a predetermined button.

Hence, the digital camera requires several operations for users to change over display patterns on the LCD or operation mode. It is considered to provide a plurality of buttons to which the respective functions are assigned for easier operation. However, this method provides increase of number of buttons according to number of operations, causing the apparatus to grow in size.

### SUMMARY OF THE INVENTION

It is an object of the present invention to provide a display apparatus or imaging apparatus with less buttons and high operability.

In order to achieve the above-mentioned object, the display unit according to the present invention includes a display section that selectively displays one of a plurality of display patterns, and has a plurality of operation modes; an operation section that receives a short-time operation which is operated by a user for a shorter period than a specified time and a long-time operation which is operated by a user for a longer period than the specified time; and a controller that controls the display section, so that the display pattern of the display section is changed over every time the operation section receives the short-time operation while the operation mode of the display section is changed over every time the operation section receives the long-time operation.

In this way the function is divided in accordance with the operating time of the operation section, it is possible to add multifunction to one operation section. Therefore, a display apparatus with high operability can be achieved by a simple configuration. In particular, the operability can be still more improved by assigning a function of change-over of display patterns with high use frequency to the short-time operation and assigning a function of change-over of the operation mode with low use frequency to long-time operation.

In addition, the controller may control the display section, so that the display pattern is returned to an initial display pattern when change-over of the display pattern by the short-time operation is repeated M times, and the operation mode is returned to an initial operation mode when change-over of the operation mode by the long-time operation is repeated N times (N<M). This configuration enables operations which require a large number of operations to be carried out in a short time, resulting in improvement of the operability still more.

Furthermore, an imaging apparatus according to the present invention is an imaging apparatus having an imaging mode to capture images and a playback mode to reproduce images. The imaging apparatus includes a display section that has a first mode to provide brightness of the screen which is relatively bright and a second mode to provide brightness of the screen which is relatively dark; an operation section that receives user instructions; and a controller that controls the display section so that the brightness of the display section is made dark when the operation section does not receive any user instruction for the time exceeding a specified time in the imaging mode, and in the playback mode the brightness of the display section is not changed even when the operation section does not receive user instruction for the time exceeding the specified time, during the first mode.

This configuration can prevent occurrence of inconvenience such as darkening of the display section during operation, while achieving energy saving of the display unit and high operability.

An imaging apparatus according to the present invention is an imaging apparatus having an imaging mode to capture images. The imaging apparatus includes a display section that has a first mode to provide brightness of the screen which is relatively bright and a second mode to provide brightness of the screen which is relatively dark; a first operation section that receives user instruction with respect to change-over of the first mode and the second mode; a second operation section that receives user instruction with respect to matters other than the change-over of the first mode and the second mode; and a controller that controls the display section so that the brightness of the display section is made dark when the operation section does not receive any user instruction for the time exceeding a specified time in the imaging mode, and when the first or second operation section receives user instruction after the display section becomes dark, the brightness of the display section is returned to the bright state, during the first mode.

This configuration makes it possible to recover brightness of the display section to the original bright state immediately by simple operation, achieving high operability.

According to the present invention, a display apparatus and imaging apparatus with less buttons and high operability can be provide.

### BRIEF DESCRIPTION OF THE DRAWINGS

FIG. 1 is a rear view of a digital camera according to the embodiment of the present invention.

FIG. 2 is a block diagram that indicates a configuration of the digital camera according to the embodiment of the present invention.

FIGS. 3A to 3D are diagrams indicating change-over of display patterns in imaging mode of the digital camera according to the embodiment of the present invention.

FIGS. 4A to 4C are diagrams indicating change-over of display patterns in playback mode of the digital camera according to the embodiment of the present invention.

### DETAILED DESCRIPTION OF THE PREFERRED EMBODIMENT

Referring now to the drawings, preferred embodiments according to the present invention will be described in detail hereinafter.

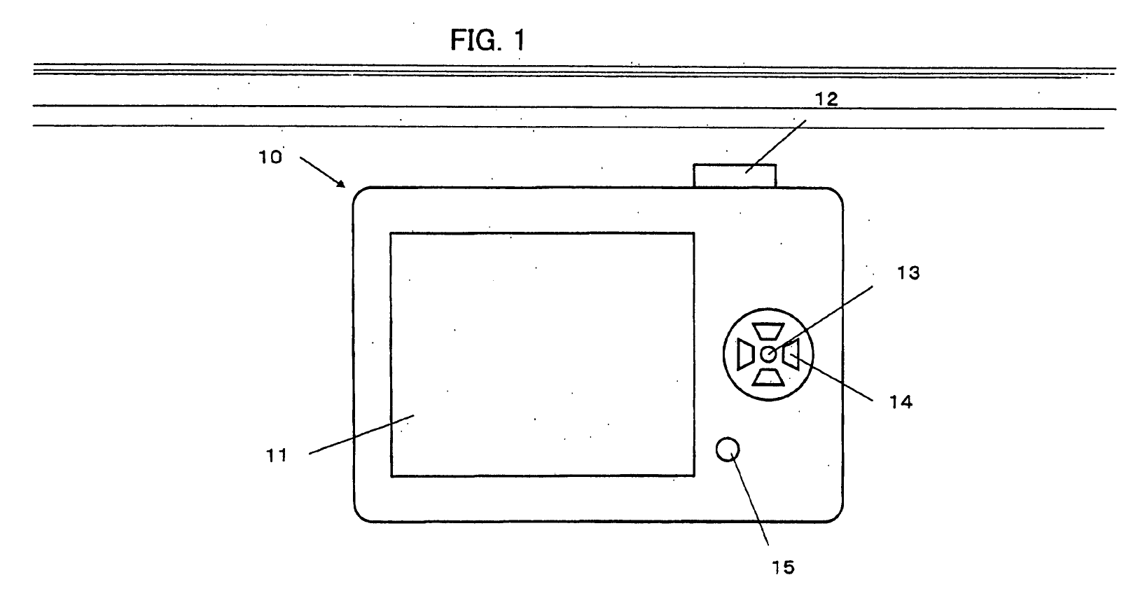

FIG. 1 is a rear view of a digital camera 10 according to the embodiment of the present invention. The digital camera 10 includes an LCD monitor 11 and display change over button 15. As illustrated, a shutter button 12, menu button 13, and cursor key 14 may be equipped.

The LCD monitor 11 displays captured images and various types of information. The various types of information includes information concerning captured images and operation conditions of the digital camera. The information concerning captured images includes information on white balance, information on the ISO sensitivity, image quality information, and others. The information concerning operation condition of the digital camera includes information on the battery residual quantity, information indicating energy-saving mode operating condition, information on operating sound setting, and others.

The LCD monitor 11 has two operation modes including a mode (“normal mode”) with normal brightness and a mode (“power mode”) with brightness brighter than the normal mode. In the normal mode as compared to the power mode, the screen of the LCD monitor 11 is relatively dark. In the power mode, as compared to the normal mode, the screen of the LCD monitor 11 is relatively bright. The LCD monitor 11 increases brightness as the light emission of the backlight of the LCD monitor 11 increases. For the backlight, fluorescent lamps, white LEDs, and other light-emitting devices may be used. Because the screen of the LCD monitor 11 becomes brighter than the normal mode when the LCD monitor 11 enters the power mode, a user can easily view images displayed on the LCD monitor even outdoors.

The display changeover button 15 is an operation section that accepts short-time operation which is operated by a user in a period shorter than a specified time and long-time operation which is operated by a user in a period longer than the specified time. The user change over the display pattern displayed on the LCD monitor 11 by depressing the display changeover button 15 for a period shorter than one second (this operation is called “short-time depression”). On the other hand, the user can change over brightness of the LCD monitor 11 by depressing the display changeover button 15 for a period longer than one second (hereinafter this operation is called “long-time depression”). That is, when the LCD monitor 11 is being operated in the normal mode, the monitor can be changed to operate in the power mode, and when the monitor is being operated in the power mode, the monitor can be changed to operate in the normal mode.

The display pattern means kind or layout of information display on the LCD monitor 11.

The shutter button 12 is means to start imaging (capturing) operation of the digital camera 10. The menu button 13 is a button to display a menu for various settings on the LCD monitor 11. The cursor key 14 is a button to move the cursor displayed on the LCD monitor 11.

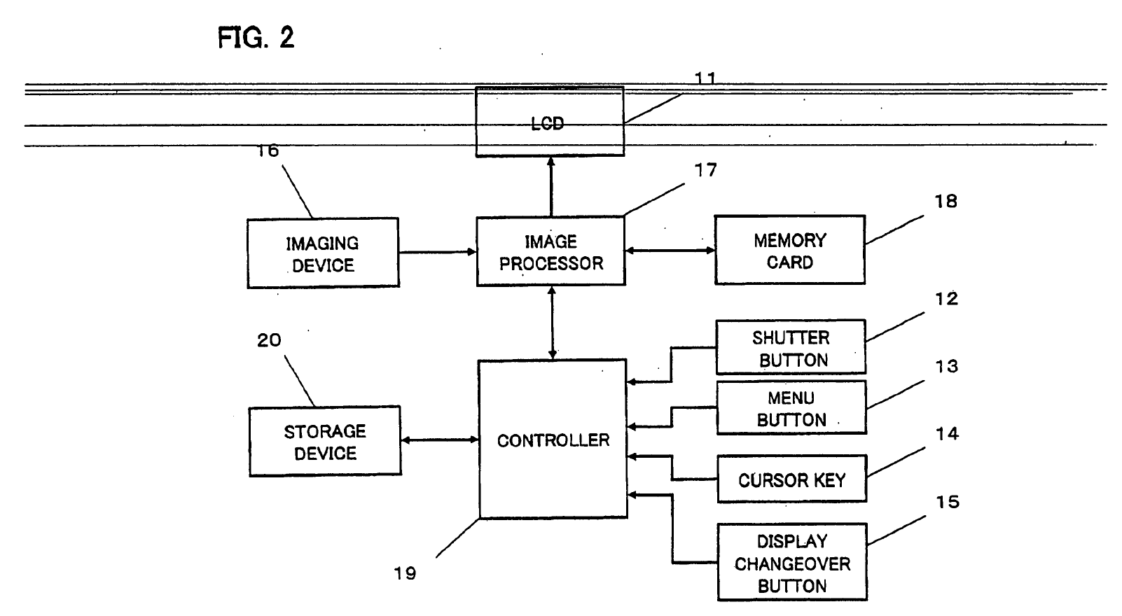

FIG. 2 shows a configuration of the digital camera 10 according to the embodiment of the present invention.

An imaging device 16 images (captures) a subject to generate image data. An image processor generate image data. An image processor 17 selectively applies white-balance processing, enlargement processing, thinning processing, compression processing and others to the captured image data to output it to the LCD monitor 11 or a memory card 18. In addition, the image processor 17 applies decompression processing, etc. to image data stored in the memory card 18 to output it to the LCD monitor 11. The memory card 18 is means to store image data captured by the imaging device 16 and image data acquired from the outside of the digital camera 10. The memory card 18 may be mounted and removed to and from the digital camera 10 and include a flash memory, etc. A storage device 20 stores display patterns, and so on displayed on the LCD monitor 11 and supplies controller data appropriately. The storage device 20 may include DRAM, SRM, flash memory, and other semiconductor memory.

A controller 19 receives instructions from the shutter button 12, menu button, 13, cursor key 14, display changeover button 15, and others, and controls the whole system of the digital camera 10 such the LCD monitor 11, imaging device 16, image processor 17, memory card 18, storage device 20, and others. The controller 19 includes a microcomputer, and so on.

The controller 19 has an imaging mode that images (captures) an image and a playback mode that plays back images. During the imaging mode, the controller 19 controls display so that image data captured by the imaging device 16 is displayed on the LCD monitor 11. On the other hand, during the playback mode, the controller 19 controls display so that the images stored in the memory card 18 is displayed on the LCD monitor 11.

The controller 19 controls the LCD monitor 11 in such a manner that the display pattern of the LCD monitor 11 is changed over every time the display changeover button 15 receives short-time depression. On the other hand, the controller 19 controls the LCD monitor 11 in such a manner that the operation mode of the LCD monitor 11 is changed over every time the display changeover button 15 receives long-time depression. In this way, since the functions are divided in accordance with the depression time of the display changeover button 15, it is possible to add multifunction to one operation section. As a result, it is possible to achieve a display apparatus having good operability with a simple configuration. In particular, a function of changing over the display pattern which is used with high frequency is assigned to the short-time depression while a function of changing over the operation mode which is used with low frequency is assigned to the long-time depression, and thus the operability can be still more improved.

In addition, the controller 19 controls the LCD monitor 11 in such a manner to return the display pattern to an initial display pattern when display pattern changeover by the short-time depression is repeated 3 or 4 times, while the controller controls in such a manner that operation mode returns to an initial operation mode when change-over of the operation mode by the long-time depression is repeated twice. The display pattern returns to the initial pattern after many operations are carried out as compared to the operation mode, and thus it is arranged that the display pattern is able to be changed over by the short-time depression. By contraries, if it is controlled to change over the display pattern circulating in three or four times by the long-time depression and to change over the operation mode circulating in twice by the short-time depression, a user takes time in changing over the display pattern and has big disadvantages. In this way, the controller 19 controls the display pattern so that the display pattern takes a round when changeover of the display pattern by the short-time depression is repeated 4 times, and that the operation mode takes a round when change over of the operation mode by the long-time depression is repeated twice. As a result, operations that require many numbers of operations can be carried out in a short time, and operability can be still more improved.

In addition, the controller 19 controls brightness to automatically return to normal brightness when thirty seconds pass after the LCD monitor 11 becomes bright when the LCD monitor 11 is in the power mode, during the imaging node. This allows energy consumption of the digital camera 10 to be saved, and therefore, for example, suppression of battery (not illustrated) consumption, etc. can be achieved.

When the digital camera 10 is in the imaging node and the there is no operation for 30 seconds or more, there would be high possibility that the user does not intend to take images and not watch the LCD monitor 11. Thus, even if brightness of the LCD monitor 11 is brought to the normal level in such an event, no inconvenience would be caused to the user. On the other hand, during the playback mode, the user may watch the reproduced image for a long time. Thus, bringing brightness of the LCD monitor 11 to the normal level due to lack of operation for 30 seconds or more may cause the user inconvenience because the user may be watching the LCD monitor 11. Consequently, in consideration of user's convenience, operation to bring brightness of the LCD monitor 11 to the normal level for 30 seconds or more is limited to the imaging mode only.

In this way, the controller 19 dims brightness of the LCD monitor 11 when the operation section of the digital camera 10 does not receive any user instruction for a period exceeding a specified time (for example, 30 seconds) in the power mode, during the imaging mode. During the playback mode, the controller 19 controls the LCD monitor 11 in such a manner not as to change brightness of the LCD monitor 11 even when the operation section of the digital camera 10 does not receive any user instruction for a period exceeding a specified time (for example, 30 seconds). This control prevents inconvenience such as darkening of the LCD monitor 11 during operation while energy-saving of the digital camera 10 is achieved, and good operability can be achieved.

Furthermore, the controller 19 controls the LCD monitor 11 so that the LCD monitor 11 is made brighter when any of the operation section is operated by the user after the LCD monitor 11 automatically returns to the normal brightness in the power mode during the imaging mode. The operation section may be formed by the shutter button, 12, menu button 13, cursor key 14, or display changeover button 15, or any other operation means. That is, not limited to operating the display changeover button 15 that changes over between the normal mode and the power mode, even when the user operates other operation means, brightness of the LCD monitor 11 is controlled to return to the original brightness.

During the imaging mode, it is considered that the user intends to take images and watch the LCD monitor 11 when the user operates any operation means. Thus, in the power mode, it is considered to be convenient for the user to bring back brightness of the LCD monitor 11 to the original bright state when any of operation means is operated. In this way, in the power mode during the imaging mode, when any of operation means does not receive any user instruction for a period exceeding a specified time, brightness of the LCD monitor 11 is dimmed, and afterward when any of the operation means receives user instruction after the LCD monitor 11 is darkened, brightness of the LCD monitor 11 is returned to the bright state. This control allows brightness of display section to be brought back immediately to the original level with simple operation while achieving energy saving of the digital camera 10 and good operability.

The LCD monitor 11 is one example of display section of the present invention. As the display section according to the present invention, organic EL monitor or inorganic EL monitor, and others can considered. The normal mode or the power mode of the LCD monitor is one example of the operation modes of the present invention. As the operation mode of the present invention, in addition to the mode to change brightness, mode to change color tone of the display section, etc. can be considered.

The display changeover button 15 is one example of the operation section or the first operation section of the present invention. The operation section or the first operation section of the present invention may be configured not only by a pushbutton but also, for example, by a slide switch or rotary dial. In short, it is only required to provide an operation section that receives a short-time operation which is operated by a user for a period shorter than a specified time, and a long-time operation which is operated by a user for a period longer than a specified time. Consequently, the operation method is not limited to the depression of the button. Furthermore, the depression for a period shorter than one second is defined as the short-time depression, and the depression for a time longer than one second is defined as the long-time depression. However this “one second” is one example of a specified time of the present invention and is not particularly limited. The short-time depression and long-time depression are one example of short-time operation or long-time operation of the present invention.

The controller 19 is one example of a control means of the present invention. In addition, it is described to control the display pattern to return to the initial condition by carrying out short-time depression 3 or 4 times. However “3 or 4 times” is one example of “M times” of the present invention. Similarly, it is described to control the operation mode to return to the initial condition by carrying out long-time depression twice. However “twice” is one example of “N times” of the present invention. In short, it is sufficient to have an N<M relation between M times and N times.

The power mode is one example of a first mode of the present invention. The normal mode is one example of a second mode of the present invention. The first mode and second mode of the present invention are not limited to this. It is only required that the first mode is relatively brighter than the second mode. For example, the normal mode may be designated as the first mode, and a power-saving mode which is darker than the normal mode, and so on may be designated as the second mode.

During the imaging mode, when the operation section does not receive any user instruction for not less than 30 minutes, brightness of the LCD monitor 11 is controlled to be dimmed. However “30 seconds” is one example of a specified time of the present invention. The specified time is not limited to this time.

The shutter button 12, menu button, 13, or cursor key 14 is one example of the second operation section of the present invention, respectively. The second operation section of the present invention is not limited to this but may be anything capable of receiving user instructions in addition to changing over between the first mode and the second mode.

The digital camera 10 is shown as one example of the display apparatus and imaging apparatus of the present invention. The display apparatus of the present invention may be a cellular phone, a car navigation system, and so on. The imaging apparatus of the present invention may be a cellular phone with camera function or an analog camera, and others.

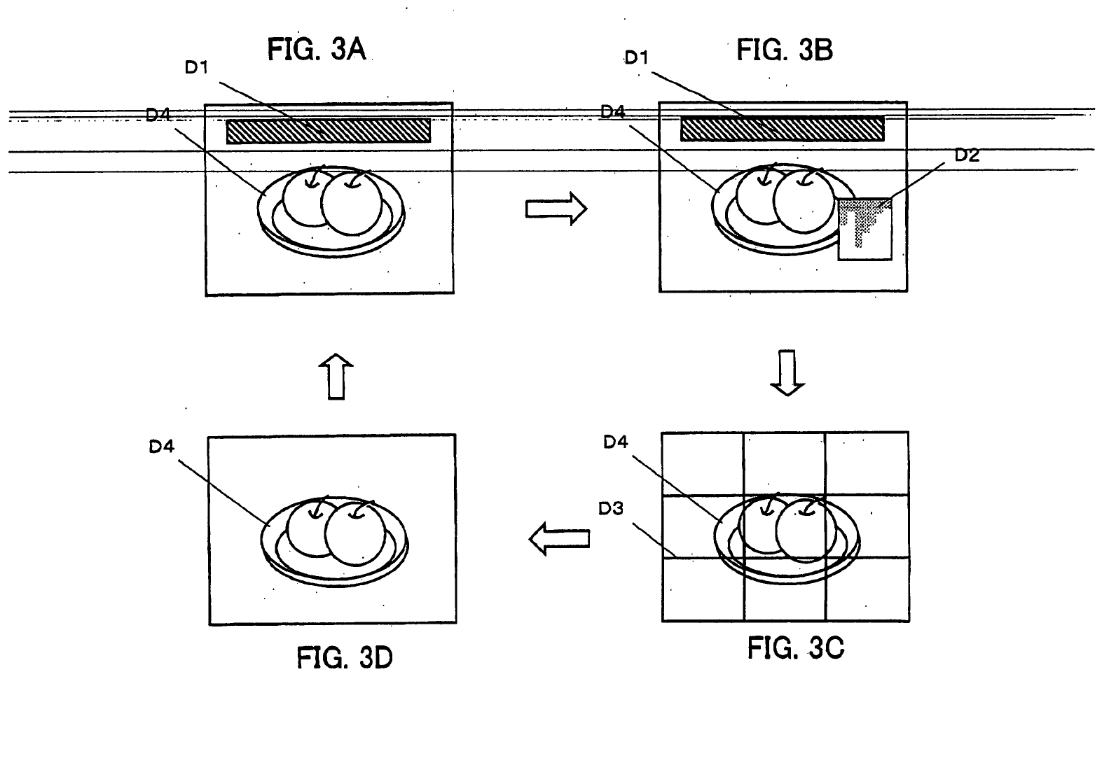

FIGS. 3A to 3D are schematic diagrams that indicate the condition how the display pattern of the LCD monitor 11 is changed over during the imaging mode. With a display pattern displayed on the LCD monitor 11 as shown in FIG. 3A, when user's depressing the display changeover button 15 once for a short time, the controller 19 changes over the display pattern to that as shown in FIG. 3B. Further depressing by the user changes over the display pattern to that shown in FIG. 3C, further depressing changes over the display pattern to that shown in FIG. 3D, and still further one depressing charges over the display pattern to that shown in FIG. 3A. In this way, the controller 19 operates the control in such a manner that when changing over of the display pattern by the short-time depression is repeated 4 times, the display pattern returns to the initial display pattern. That is, the display pattern is cyclically changed over, so that it makes a round when the short-time depression is carried out 4 times.

In FIGS. 3A to 3D, the indication D1 is various kinds of information such as battery remaining information or picture quality information, and others. The indication D2 is a histogram with image brightness on abscissa and the number of pixels of the brightness on ordinate. The user can judge exposure condition of the image by looking the shape (distribution of the graph) of the histogram of the image captured. The indication D3 is a guideline for imaging. The user can easily determine composition while observing the size, gradient, balance of the subject when the subject is arranged on the intersection point of longitudinal and perpendicular lines or on the line. The display D4 is a through image. The through image D4 is displayed as a background image of indications D1 to D3. The through image is an image that displays the image captured by the imaging device 16 on the LCD monitor 11 without storing the image in the memory card 18. Displaying this through image on the LCD monitor 11 during the imaging made allows the user to decide easily the composition to take an image which is stored finally in the memory card 18.

FIG. 3A is a display pattern with the indication D1 displayed on the through image D4. FIG. 3B is a display pattern with the indication D1 and the histogram D2 displayed on the through image D4. FIG. 3C is a display pattern with the guideline D3 over the through image D4, and with the indication D1 and histogram D2 disappearing. FIG. 3D is a display pattern with the through image D4 only displayed.

It is noted that depressing the display changeover button 15 once for a long time brings the LCD monitor 11 to the power mode under the control of the controller 19, brightening the screen, as described earlier. Such an operation takes place similarly independently of display modes in FIGS. 3A to 3D by the LCD monitor 11. In addition, depressing the display changeover button 15 once again for a long time changes over the LCD monitor 11 from the power mode to the normal mode, and the brightness is returned to the regular level. In this way, the controller 19 operates the control so that the operation mode returns to the initial mode when the changed over of the operation mode is repeated twice by the long-time depression. That is, the operation mode is cyclically changed over in such a manner that the mode makes a round by two long-time depressions.

Since the operation in FIGS. 3A to 3D is an operation during the imaging mode, the controller 19 brings the brightness of the LCD monitor 11 to the regular level, when no operation is done for not less than 30 seconds while the LCD monitor 11 is kept bright. This control is applied similarly independently of display patterns on the LCD monitor 11.

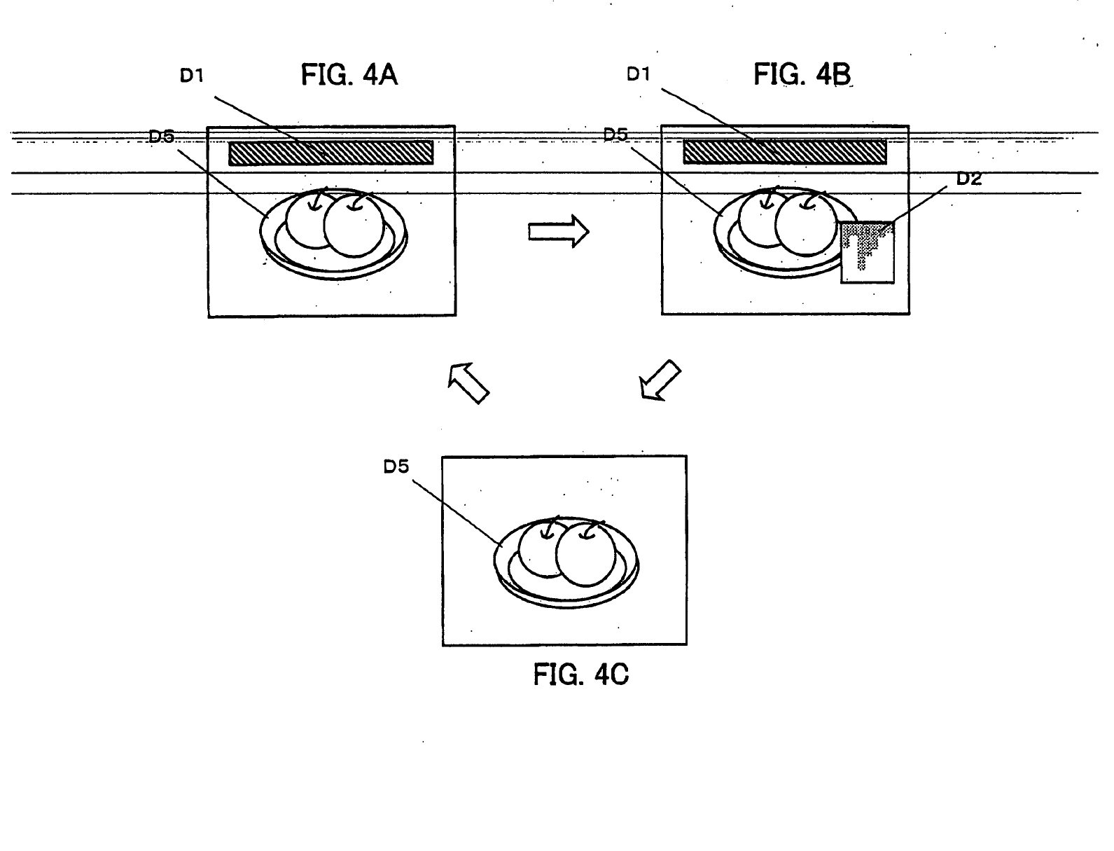

FIGS. 4A to 4C are schematic diagrams that indicate the condition how the display pattern of the LCD monitor 11 is changed over during the playback mode. With a display pattern displayed on the LCD monitor 11 as shown in FIG. 4A, when user's depressing the display changeover button 15 once for a short time, the controller 19 changes over the display pattern to that as shown in FIG. 4B. Further depressing by the user changes over the display pattern to that shown in FIG. 4C, further depressing changes over the display pattern to that shown in FIG. 4D, and still further one depressing changes over the display pattern to that shown in FIG. 4A. In this way, the controller 19 operates the control in such a manner that when changing over of the display pattern by the short-time depression is repeated 3 times, the display pattern returns to the initial display pattern. That is, the display pattern is cyclically changed over, so that it makes a round when the short-time depression is carried out 3 times.

In FIGS. 4A to 4C, the display D5 is a reproduced image. The reproduced image D5 is displayed as a background image of displays D1 and D2. The reproduced image is an image displayed on the LCD monitor which is stored in the memory card 18.

FIG. 4A shows a display pattern with the indication D1 displayed on the reproduced image D5. FIG. 4B is a display pattern with the indication D1 and histogram D2 displayed on the reproduced image D5. FIG. 4C is a display pattern with the reproduced image. D5 only displayed. In this way, the display pattern of the LCD monitor 11 is able to be changed in accordance with the operation mode (imaging mode, playback mode, and others.) of the digital camera 10. Thus, an appropriate display screen can be displayed in accordance with the operation mode of the digital camera 10. As shown above, during the playback mode, the image guideline D3 is not displayed because of it's un-necessity. Hence, one circulation of display patterns by the short-time depression can be reduced and the user operation can be still more facilitated.

It is noted that depressing the display changeover button 15 once for a long time brings the LCD monitor 11 to the power mode under the control of the controller 19, brightening the screen, as described earlier. Such an operation takes place similarly independently of display modes in FIGS. 4A to 4C by the LCD monitor 11. In addition, depressing the display changeover button 15 once again for a long time changes over the LCD monitor 11 from the power mode to the normal mode, and the brightness is returned to the regular level.

Since the operation in FIGS. 4A to 4C is an operation during the playback mode, the controller 19 maintains the brightness of the LCD monitor 11 as bright even when no operation is done for not less than 30 seconds while the LCD monitor 11 is kept bright. This control is applied similarly independently of display patterns on the LCD monitor 11.

The display apparatus and imaging apparatus of the present invention provides superb operability on the display, and thus the can be applied to cellular phones and cellular phones with camera functions, analog cameras, and others in addition to digital cameras.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2004-211306, filed on Jul. 20, 2004, which is expressly incorporated herein by reference in its entirety.

What is claimed is:

1. A display apparatus comprising:
a display section that selectively displays one of a plurality of display patterns, and has a plurality of operation modes;
an operation section that receives a short-time operation which is operated by a user for a shorter period than a specified time and a long-time operation which is operated by a user for a longer period than the specified time; and
a controller that controls the display section, so that the display pattern of the display section is changed over every time the operation section receives the short-time operation while the operation mode of the display section is changed over every time the operation section receives the long-time operation.

2. The display apparatus according to claim 1, wherein the controller controls the display section, so that the display pattern is returned to an initial display pattern when change-over of the display pattern by the short-time operation is repeated M times, and the operation mode is returned to an initial operation mode when change-over of the operation mode by the long-time operation is repeated N times (N<M).

3. An imaging apparatus having an imaging mode to capture images and a playback mode to reproduce images, comprising:
a display section that has a first mode to provide brightness of the screen which is relatively bright and a second mode to provide brightness of the screen which is relatively dark;
an operation section that receives user instructions; and
a controller that controls the display section so that the brightness of the display section is made dark when the operation section does not receive any user instruction for the time exceeding a specified time in the imaging mode, and in the playback mode the brightness of the display section is not changed even when the operation section does not receive user instruction for the time exceeding the specified time, during the first mode.

4. An imaging apparatus having an imaging mode to capture images, comprising:
a display section that has a first mode to provide brightness of the screen which is relatively bright and a second mode to provide brightness of the screen which is relatively dark;
a first operation section that receives user instruction with respect to change-over of the first mode and the second mode;
a second operation section that receives user instruction with respect to matters other than the change-over of the first mode and the second mode; and
a controller that controls the display section so that the brightness of the display section is made dark when the operation section does not receive any user instruction for the time exceeding a specified time in the imaging mode, and when the first or second operation section receives user instruction after the display section becomes dark, the brightness of the display section is returned to the bright state, during the first mode.
